(19) United States
(12) Patent Application Publication
(10) Pub. No.: US 2017/0110224 A1
(43) Pub. Date: Apr. 20, 2017

(54) CABLE FIXATOR

(71) Applicant: NEW GREEN CO., LTD., Busan (KR)

(72) Inventor: Bu Geun KIM, Busan (KR)

(21) Appl. No.: 14/885,790

(22) Filed: Oct. 16, 2015

(51) Int. Cl. H01B 17/30; H02G 3/04; F16L 3/26

(52) U.S. Cl. CPC H01B 17/30; F16L 3/26; H02G 3/0462

(57) ABSTRACT

A cable fixator includes: a first member formed in a cylindrical shape with a through hole inside; a protrusion formed on one side of the first member and inserted in the through tube after the first screw thread provided; a first fastener formed in a ring shape and combined with the protrusion by the combining grooves; a second screw thread formed on the inner side of the first member; a second member formed in a cylindrical shape and inserted into the inside of the first member; a second fastener formed on one side of the second member; a third screw thread formed on the outside of the second member and combined with the second screw thread; a sealing member consisting of a soft material; a sealing groove formed on the outer surface of the sealing member and provided with grooves toward the inside of the sealing member.

### BACKGROUND OF THE INVENTION

Field of the Invention

The present invention relates to a cable fixator, more specifically provided at one side of electric field equipment, fixing a cable to the center of cable fixator when a cable in an electric field equipment is drawn to the outside of the electric field equipment, and configuring the joint formed in a tooth shape in a safe way.

Description of Related Art

In general, cable fixator is a device that is provided on one side of an electric field equipment to control an electrical or electronic equipment used in industrial field, ships, buildings, etc. and is configured to fix a cable to go into control box.

More specifically, the cable fixator that is provided in a through tube that can accommodate a cable on one side of an electric field equipment prevents water or dust from coming into the electric field equipment via through tube and serves to ensure that the cabled inserted in the electric field equipment is divided into each electrical or electronic equipment while fixed on the cable fixator.

In a conventional cable fixator, when a cable is inserted into a through tube of the cable fixator, a space is generated between the inner diameter of the through tube and the outer diameter of the cable, causing damage to the cable. In addition, there is a problem that an operator can be injured when gripping a tooth-shaped cable fixator joint.

### SUMMARY OF THE INVENTION

Technical Problem: The present invention aims to provide a cable fixator that can fix a cable coming into an electric field equipment on the center of the aforesaid the first member and second member by using a fixture that is provided to the inside of either one of the first member to be fixed on the electric field equipment and the second member to be fixed to the first member.

The present invention also aims to provide a cable fixator that enables the sealing member, provided between the aforesaid the first and the second member, to apply pressure to the outer surface of the aforesaid cable to keep it sealed by the pressing force generated during the tightening of the aforesaid the first and the second member.

The present invention will not be limited to the embodiments set forth herein but may be embodied in many different forms. Rather, the embodiments introduced here are provided to make this disclosure thorough and complete and to transmit the concept of this invention to those skilled in the art.

Solution to Problem: The present invention relates to the cable fixator that comprises: the first member that is formed in a cylindrical shape, with through hole inside; the protrusion that is formed on one side of the aforesaid the first member and inserted in the through tube of the aforesaid electric field equipment after being provided with the first screw thread on its outer surface; the first fastener that is formed in a ring shape and combined with the aforesaid protrusion by using the combining grooves that are formed at equal intervals along the outer surface; the second screw thread that is formed on the inner side of the aforesaid the first member; the second member that is formed in a cylindrical shape with through tube formed inside and that is inserted into the inside of the aforesaid the first member; the second fastener that is formed on one side of the aforesaid second member, protruding outward from the aforesaid second member, and that is equipped with combining groove spaced at equal intervals; the third screw thread that is formed on the outside of the aforesaid second member and that is combined with the aforesaid second screw thread; the sealing member consisting of a soft material that is provided in between the aforesaid the first member and the second member; and the sealing groove that is formed on the outer surface of the aforesaid sealing member and provided with grooves toward the inside of the aforesaid sealing member. The invention is also characterized in that the aforesaid protrusion is inserted so that one side of the aforesaid the first member is seated on the through tube of the aforesaid electric field equipment, in that the aforesaid the first fastener fixes the aforesaid the first member to the aforesaid electric field equipment after being fastened by the first screw thread and in that the inner surface of the aforesaid sealing member protrudes toward the inside of the aforesaid the first and the second member to meet the outer surface of the aforesaid cable when the aforesaid sealing member contracts in a longitudinal direction by the pressing force generated during the fastening of the aforesaid the first member and the second member.

On one of the inner sides of the aforesaid the first and the second member, the fixture for cable fixing to be provided on the inner sides of the aforesaid the first and the second member is provided on the rear end of the aforesaid fixture and the fixture spring to apply pressure to the aforesaid fixture in an inner direction of the aforesaid the first or the second member is included. The aforesaid fixture is characterized in that it applies pressure to the outer surface of the cable installed to pass through the inside of the aforesaid the first and the second member.

The aforesaid fixture, provided on one of the inner sides of the aforesaid the first and the second member, is characterized in that at least one is provided independently to fix the cable that is provided in the inside of the aforesaid the first and the second member.

Between the upper surface of the aforesaid the first member and the outer surface of the aforesaid electric field equipment, an O-ring is provided so that the aforesaid the first member is in close contact with the outer surface of the aforesaid electric field equipment.

On the rear cross sections of the aforesaid the first and the second fastener is provided a cover that moves toward the aforesaid combining groove to open and close the aforesaid combining groove.

On one side of the aforesaid cover is provided a cover lug that is formed while protruding to the inside of the aforesaid the first and the second fastener. Between the rear cross sections of the aforesaid the first and the second fastener and the aforesaid cover lug is provided a elastic cover spring so that the aforesaid cover moves toward the fastening groove to open and close the aforesaid fastening groove.

To the aforesaid the first and the second fastener is provided a guiding line that is formed wrapping around the outer surface of the aforesaid cover. The aforesaid guiding line is characterized in that the aforesaid cover serves to guide the movement toward the aforesaid fastening groove.

Beneficial Effects: The cable fixator of the present invention is expected to have an effect to fix the cable coming to the electric field equipment in the inner center of the aforesaid the first and the second member by the fixture that is provided on one side of either the first member fixed on the electric field equipment or the second member fixed on the first member.

In addition the sealing member, provided between the aforesaid the first and the second member, can apply pressure to the outer surface of the aforesaid cable to be kept sealed by using the pressure generated by the fastening of the aforesaid the first and the second member.

### BRIEF DESCRIPTION OF THE DRAWINGS

FIG. 1 is a perspective view of the cable fixator of the present invention.

FIG. 2 is an exploded perspective view of the cable fixator of the present invention.

FIG. 3 is a side cross-sectional view of the cable fixator of the present invention.

FIG. 4 is a partial plan view of the cable fixator cover of the present invention.

FIG. 5 is a perspective view of the fastening device of the cable fixator of the present invention.

### DETAILED DESCRIPTION OF THE PREFERRED EMBODIMENTS

The benefits and characteristics of the present invention and the implementing methods may be understood more readily with reference to the embodiments to be described below in detail along with attached drawings.

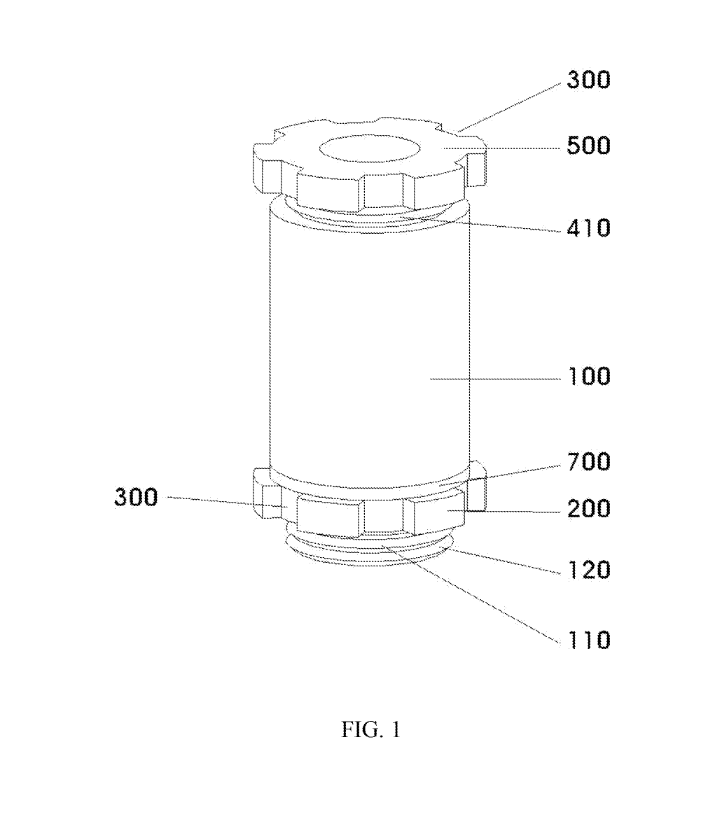

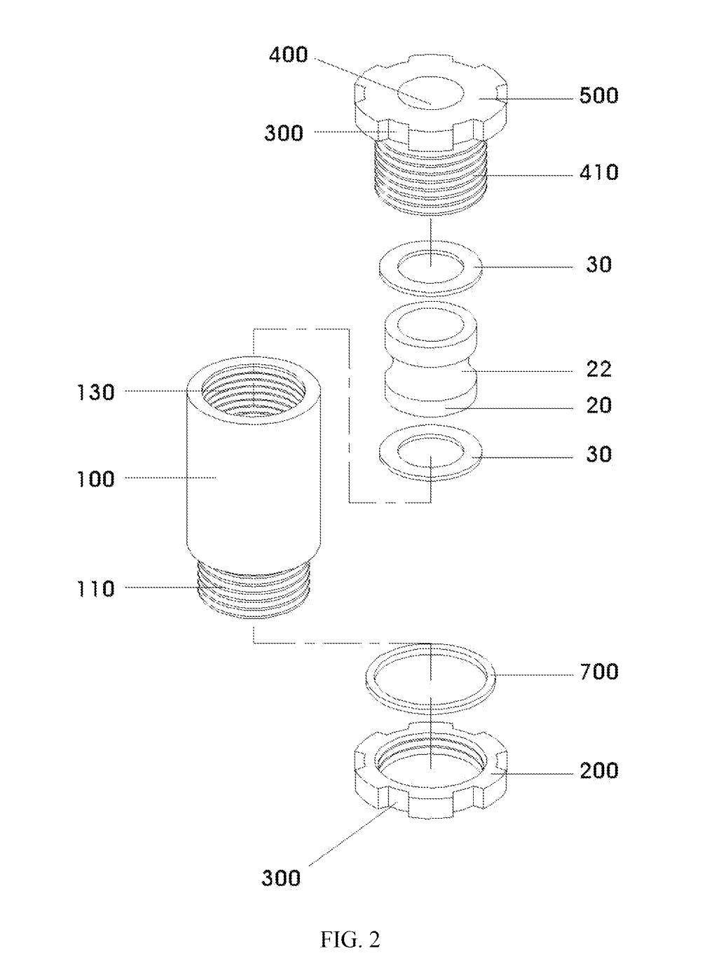

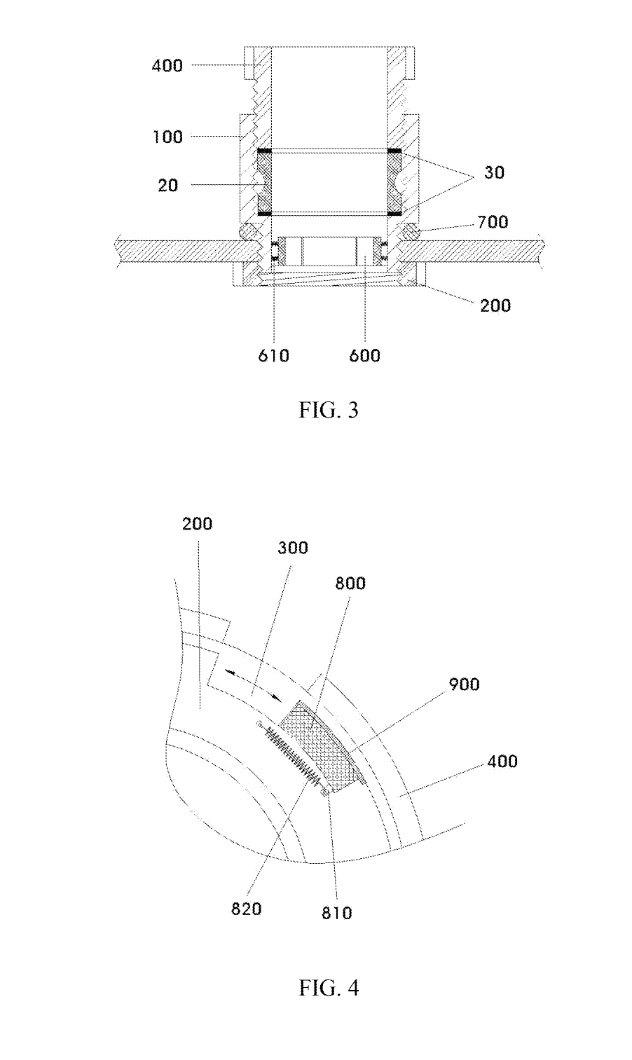

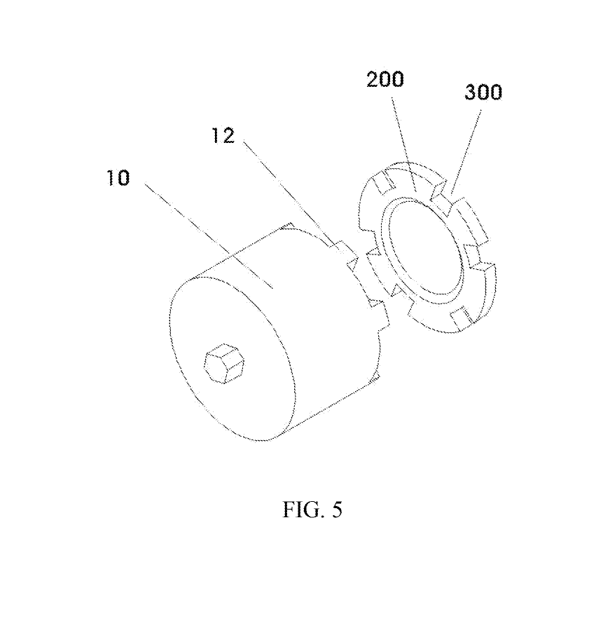

First, as shown in the FIG. 1, the present invention comprises: the first member (100) to be installed penetrating the through tube of the electric field equipment; the protrusion (110) to be formed on one side of the aforesaid the first member (100) and to be inserted in the through tube of the aforesaid electric field equipment after being provided with the first screw thread (120) on its outer surface; the first fastener (200) to be formed in a ring shape to surround the aforesaid protrusion and to be combined to the aforesaid protrusion by the combining grooves (300) that are formed at equal intervals along the outer surface; the second screw thread (130) to be formed on the inner surface of the aforesaid the first member (100); the second member (400) to be inserted into the aforesaid the first member (100); the second fastener (500) to be formed on one side of the aforesaid second member (400) and to be provided with combining grooves that protrude from the aforesaid second member (400) at equal intervals along the outer surface; the third screw thread (410) to be formed on the outer surface of the aforesaid second member (400) and to be combined with the aforesaid second screw thread (130); the fixture (600) to be provide on one side of either the aforesaid the first member (100) or the second member (400), fixing the cable that is provided on the inner side of the aforesaid the first member (100) and the second member (400); and the fixture spring (610) to be provided on the rear end of the aforesaid fixture (600) in order to push the aforesaid fixture (600) to the inner side of the aforesaid the first member (100) or the second member (400).

First, the cable fixator of the present invention is provided with the first member (100). The aforesaid the first member (100) is formed in a cylindrical shape with through hole inside. That is, the aforesaid the first member (100) serves to insert the cable (C) that is inserted to the inner side of the electric field equipment into the through tube formed inside.

On one side of the aforesaid the first member (100) is provided the protrusion (110). The aforesaid protrusion (110) is formed to protrude on one side of the aforesaid the first member (100) and inserted into the through tube of the aforesaid electric field equipment. In other words, the aforesaid protrusion (110) is provided with through hole to be linked with the through hole of the aforesaid the first member (100) so that the aforesaid cable (C) can be inserted. In addition, the outer diameter of the aforesaid protrusion (110) is formed to be smaller than that of the aforesaid protrusion (110). This serves to make it possible that the aforesaid protrusion (110) is inserted into the through tube of the aforesaid electric field equipment and that one side of the aforesaid the first member (100) is seated on the outer surface of the aforesaid electric field equipment.

Further, on the outer surface of the aforesaid protrusion (110) is provided the first screw thread (120). The aforesaid the first screw thread (120) is fixed by a screw thread, when the aforesaid protrusion (110) is inserted into the through tube of the aforesaid electric field equipment, and combined with screw thread of the first fastener (200) to be described later in order to fix the first member (100) to the aforesaid electric field equipment.

In addition, the cable fixator of the present invention is provided with the first fastener (200). The aforesaid the first fastener (200) is formed in a ring shape, with the combining grooves (300) formed at equal intervals along the outer surface. That is, the aforesaid the first fastener (200) has a screw thread, on its ring-shaped inner surface, to be combined with the aforesaid the first screw thread (120) and serves to keep the aforesaid protrusion (110) inserted in the through tube of the field equipment in a fixed state without disengagement.

Moreover, the cable fixator of the present invention is provided with the fastening device (10). The aforesaid fastening device (10) is formed in a cylindrical shape and provided with fastening protrusion (12) to be inserted into the aforesaid combining groove (300) formed at equal intervals. In other words, when the aforesaid fastening protrusion (12) rotates while inserted into the aforesaid combining groove (300), the aforesaid the first fastener (200) rotates along with the aforesaid the first screw thread (120) so that the aforesaid fastening device (10) moves to the inner side of the aforesaid electric field equipment. This makes it possible that the aforesaid the first fastener (200) is easily combined with the aforesaid the first member (100) by using the aforesaid fastening device and power tools.

On the inner side of the aforesaid the first member (100) is provided the second screw thread (130). The aforesaid second screw thread (130) is provided with the aforesaid the first member (100) on its inner surface and combined with the third screw thread (410) to be described below

In addition, the cable fixator of the present invention is provided with the second member (400). The aforesaid second member (400) is formed in a cylindrical shape with through tube inside and inserted into the aforesaid the first member (100). That is, the outer diameter of the aforesaid second member (400) is formed to be smaller that of the aforesaid the first member (100) so that the aforesaid second member (400) is inserted into the aforesaid the first member (100). In addition, the through tube formed in the aforesaid second member (400) serves to ensure that the cable (C) is inserted into the electric field equipment.

Further, on the outer surface of the aforesaid second member (400) is provided the third screw thread (410). The aforesaid third screw thread (410) serves to ensure that the aforesaid second member (400) and the aforesaid the first member (100) are combined with each other when they are inserted into the aforesaid the first member (100), in order to avoid the departure of the aforesaid second member (400) from the aforesaid the first member (100).

In addition, on one side of the aforesaid second member (400) is provided the second fastener (500). The aforesaid second fastener (500) comprises the combining grooves (300) that are formed to protrude outwardly on the opposite side of the aforesaid the first member (100), along the outer surface of the aforesaid the second member (400) at equal intervals. In other words, the aforesaid second fastener (500) is configured in the same manner as the aforesaid the first fastener (200) described above, except for the extension of the aforesaid second member (400). In addition, the aforesaid second fastener (500) rotates by the above-described fastening device (10) and the aforesaid the second member (400) is inserted into the aforesaid the first member (100) while the aforesaid the second member (400) is fixed to the inside of the aforesaid the first member (100) by the aforesaid the second screw thread (130) and the third screw thread (410).

The fixture (600) is provided on the inner side of either the aforesaid the first member (100) or the second member (400). The aforesaid fixture (600) fixes the aforesaid cable (C) that is inserted into the aforesaid the first member (100) and the second member (400). The aforesaid cable installed in the aforesaid the first member (100) and the second member (400) is fixed by the force of the aforesaid fixture (600) that is applied to the inner direction of the aforesaid the first member (100) and the second member (400). That is, the aforesaid fixture (600) prevents the aforesaid cable (C) from being spaced or escaped by an external force in the aforesaid the first member (100) and the second member (400) and safely fixes the aforesaid cable (C) that is branched from the inside of the aforesaid electric field equipment.

The aforesaid fixture spring (610) is provided to the rear end of the aforesaid fixture (600) and generates the pressure to force the aforesaid fixture (600) toward the inside of the aforesaid the first member (100) or the second member (400). In other words, the aforesaid fixture spring (610) pushes, by its elastic force, the aforesaid fixture (600) toward the inside of the aforesaid the first member (100) or the second member (400) to fix the aforesaid cable (C).

In addition, the aforesaid fixture (600) is provided independently on the inner surface of either the aforesaid the first member (100) or the second member (400) in order to fix the aforesaid cable that is provided on the inner surface of the aforesaid the first member (100) or the second member (400). This serves to allow the wrapping of all of the outer surface of the aforesaid cable (C) having different inside diameters depending on the configuration of the aforesaid cable (C) to be inserted into the aforesaid electric field equipment. In other words, when a plurality of the aforesaid cable (C) is provided, since a space is generated between the aforesaid fixture (600) and the cable (C), a plurality of fixture (600) is provided to minimize the space between the aforesaid cable (C) and the fixture(600) and to secure a stable fixing.

Further, between the aforesaid the first member (100) and the second member (400) is provided a soft sealing member (20). The aforesaid sealing member (20) is provided between the step inside the aforesaid the first member (100) and the upper surface of the second member (400) inserted into the aforesaid the first member (100). In other words, the aforesaid sealing member (20) contracts by the pressing force generated when the aforesaid the first member (100) and the second member (400) are fastened by the aforesaid second screw thread (130) and the third screw thread (410). In this case, while contracting in the longitudinal direction resulting in the contraction of the inner diameter, the aforesaid sealing member (20) adheres to the outer peripheral surface of the aforesaid cable (C). This serves to keep the distance of the aforesaid cable (C), the aforesaid the first member (100) and the second member (400) to a minimum to prevent water and dust from entering the inside of the aforesaid electric field equipment.

Further, a washer (30) can be provided on the upper and lower end of the aforesaid sealing member (20). The aforesaid washer (30) serves to ensure that the same pressure is applied to the upper and lower surface of the aforesaid sealing member (20) when the aforesaid the first member (100) and the second member (400) are fastened by the aforesaid second screw thread (130) and the third screw thread (410).

Further, a sealing groove (22) is provided on the outer surface of the aforesaid sealing member (20). The aforesaid sealing groove (22) serves to ensure that the inner surface of the aforesaid sealing member (20) is bent in a natural manner toward the inside of the aforesaid the first member (100) and the second member (400) by the pressing force generated when the aforesaid the first member (100) and the second member (400) are fastened by the aforesaid second screw thread (130) and the third screw thread (410).

In addition, a sealing film (not shown) is formed on one side of the aforesaid sealing member (20). The aforesaid sealing film (not shown) is formed on one side of the aforesaid sealing member (20) and, when the aforesaid cable (C) is inserted to the aforesaid electric field equipment, allows the aforesaid cable (C) to pass through the aforesaid sealing film (not shown). That is, while the aforesaid cable (C) is pushed in between the aforesaid sealing member (20) and the sealing film (not shown) is passed through, the fracture surface of the aforesaid sealing film (not shown) meets the outer surface of the aforesaid cable (C) so as to prevent dust and water from entering the aforesaid electric field equipment by the aforesaid sealing film (not shown).

Further, an O-ring (700) is provided between the upper side of the aforesaid the first member (100) and the outer surface of the aforesaid electric field equipment. When the aforesaid the first member (100) adheres to the aforesaid electric field equipment by the aforesaid the first fastener (200) the aforesaid O-ring (700) is pressed to tighten the space between the upper side of the aforesaid the first member (100) and the outer surface of the aforesaid electric field equipment. This serves to seal the space between the upper side of the aforesaid the first member (100) and the outer surface of the aforesaid electric field equipment in order to prevent water and dust from entering the aforesaid electric field equipment.

A cover (800) is provided in the aforesaid the first fastener (200) and the second fastener (500). The aforesaid cover (800) is provided on the rear cross-section of the aforesaid the first fastener (200) and the second fastener (500) and is moved toward the combining groove (300) of the aforesaid the first fastener (200) and the second fastener (500) and serves to open and close the aforesaid combining groove (300). That is, the aforesaid cover (800) opens the aforesaid combining groove (300), when the aforesaid combining groove (300) is used by the aforesaid fastening device (10), and moves toward the aforesaid combining groove (300) closes the aforesaid combining groove (300) so as to prevent any injury of operator or user by the structural features of the first fastener (200) and the second fastener (500) formed in a serrated shape.

Further, a cover lug (810) is provided on one side of the aforesaid cover (800). The aforesaid cover lug (810) to be provided on one side of the aforesaid cover (800) is formed to protrude toward the aforesaid the first fastener (200) and the second fastener (500). This serves to fasten the cover spring (820) so that the aforesaid cover (800) automatically moves toward the aforesaid combining groove (300).

In addition, a cover spring (820) is provided between the rear cross-section of the aforesaid the first fastener (200) and the second fastener (500) and the aforesaid cover lug (810). The aforesaid cover spring (820) serves to move the aforesaid cover (800) toward the aforesaid combining groove (300).

In addition, a guiding line (900) is provided in the aforesaid the first fastener (200) and the second fastener (500). The aforesaid guiding line (900) to be provided on the rear cross-section of the aforesaid the first fastener (200) and the second fastener (500) and formed to surround the outer surface of the aforesaid cover (800). In other words, the aforesaid guiding line (900) serves to guide the aforesaid cover (800) to the aforesaid combining groove (300) with the help of the aforesaid cover spring (820).

As mentioned above, it will be understood that the technical configuration of the invention described above may be embodied in specific forms by those skilled in the art of the present invention without changing the technical idea or essential features of the present invention.

Therefore, it should be understood that the embodiments described above are intended to be illustrative in all respects to be understood as non-limiting, that the scope of the present invention appears in the claims below rather than by the description above, and that the spirit and scope of the claims and all the changes or modified forms deriving from its equivalents fall within the scope of the present invention.

1. A cable fixator comprises:
a first member formed in a cylindrical shape with a through hole inside;
a protrusion formed to protrude on one side of the first member and to be inserted into a through tube of an electric field equipment, with a first screw thread on an outer surface of the protrusion;
a first fastener formed in a ring shape with a combining groove formed along the outer surface of the protrusion at equal intervals and bonded with the protrusion;
a second screw thread formed inside the first member;
a second member formed in another cylindrical shape, with the through tube inside and inserted into the first member;
a second fastener formed on one side of the second member so as to protrude toward the outside of the second member and provided with the combining groove formed at equal intervals along the outer surface of the protrusion;
a third screw thread formed on the outer surface of the second member and combined with the second screw thread;
a. sealing member provided in between the first member the second member and consisting of a soft material; and
a sealing groove formed on the outer surface of the sealing member and provided with grooves toward an inner surface of the sealing member,
wherein, the protrusion is inserted so that one side of the first member is seated in the through tube of the electric field equipment, and the first fastener is fastened by the first screw thread to fix the first member to the electric field equipment, and
when the sealing member contracts in a longitudinal direction by the pressing force generated during the fastening of the first member and the second member, the inner surface of the sealing member protrudes toward the inside of the first member and the second member and meets the outer surface a cable.

2. The cable fixator of claim 1, further comprising:
a cable fixing fixture provided on one side of either of the first member or the second member; and
a fixture spring provided at an rear end of the cable fixing fixture and to press the cable fixing fixture toward the inside of either the first member or the second member, wherein,
the cable fixing fixture fixes the outer surface of the cable, installed to pass through the inside of the first member and the second member, by pressing it toward the inside of the first member and the second member.

3. The cable fixator of claim 2, wherein:
the cable fixing fixture is provided on one side of either the first member or the second member so as to fix the cable to be provided on the inner surface of the first member and the second member.

4. The cable fixator of claim 1, wherein:
an O-ring is provided in between a upper surface of the first member and the outer surface of the electric field equipment so that the first member adheres to the outer surface of the electric field equipment.

5. The cable fixator of claim 1, wherein:
a cover is provided on an rear cross-section of the first fastener and the second fastener and moves toward the combining groove to open or close the combining groove.

6. The cable fixator of claim 5, wherein:
a cover lug is formed on one side of the cover to protrude toward the inside of the first fastener and the second fastener;
an elastic cover spring is provided between the rear cross-section of the first fastener and the second fastener and the cover lug, wherein
the cover moves toward a fastening groove to close the fastening groove.

7. The cable fixator of claim 5, wherein:
the first fastener and the second fastener are provided with a guiding line surrounding the outer surface of the cover; and
the guiding line guides the cover o the fastening groove with the help of the elastic cover spring.

8. The cable fixator of claim 6, wherein:
the first fastener and the second fastener are provided with a guiding line surrounding the outer surface of the cover; and
the guiding line guides the cover to the fastening groove with the help of the elastic cover spring.
